(19) United States
(12) Patent Application Publication
(10) Pub. No.: US 2008/0037554 A1
(43) Pub. Date: Feb. 14, 2008

(54) COMMUNICATION DEVICE HAVING A COST SAVING OPERATION MODE

(75) Inventors: Michael T. Vincent, Lake Worth, FL (US); Daniel A. Baudino, Lake Worth, FL (US)

Correspondence Address: CUENOT & FORSYTHE, L.L.C., 12230 FOREST HILL BLVD., SUITE 120, WELLINGTON, FL, 33414, US

(73) Assignee: MOTOROLA, INC., Schaumburg, IL (US)

(21) Appl. No.: 11/463,658

(22) Filed: Aug. 10, 2006

(51) Int. Cl. H04L 12/56

(52) U.S. Cl. 370/395.42

(57) ABSTRACT

A method (200) for communicating messages (170, 175). A priority level can be associated with a message, and a time in which to communicate the message can be automatically selected based on the associated priority level and a communication rate plan (165). The message can be automatically communicated at the selected time. A subscriber communication rate plan can be queried to determine when there is a discounted communication rate or when free communications are available. The message can be communicated immediately if the priority that is associated with the message is high. The present invention also relates to a method (500) for processing calls. An inbound call (405) can be received and a priority level can be associated with the call. The call can be automatically sent to voice mail if the priority level is low or a call session can be established if the priority level is high.

### BACKGROUND OF THE INVENTION

1. Field of the Invention

The present invention generally relates to communication services and, more particularly, to communication services for which service charges may vary with respect to time.

2. Background of the Invention

The use of mobile stations has grown to an extent that such devices are now ubiquitous throughout most of the industrialized world. Just as their use has grown, so too has the functionality of mobile stations. Indeed, mobile stations now can be used not only for voice communications, but also to perform a number of other tasks. For example, mobile stations can be used to take photographs and capture and stream video, browse the Internet, play games, and send and receive instant messages and e-mail.

The additional functionality that has been added to mobile stations in recent years has provided new sources of revenue for communication service providers. For example, wireless communication service providers typically charge consumers for use of instant messaging and Internet browsing services. The rates for such services vary, becoming most expensive when demand peaks during the day and least expensive when demand subsides late in the evening. Unfortunately, many consumers do not know when the rates for their communication service providers change. Moreover, for those consumers who do know when the rates change, waiting until the rates drop late in the evening, or on a weekend, to use communication services can be inconvenient.

### SUMMARY OF THE INVENTION

The present invention relates to a method for communicating messages. The method can include associating a priority level with a message and automatically selecting a time in which to communicate the message based on, at least in part, the associated priority level and a communication rate plan. The message can be automatically communicated at the selected time. Selecting the time to communicate the message can include querying the subscriber communication rate plan to determine when there is a discounted communication rate or when free communications are available. Further, automatically communicating the message at the selected time can include communicating the message immediately in response to a high priority being associated with the message.

Automatically communicating the message also can include communicating the message to an alternate e-mail address. For example, a size of the message can be determined, and the message can be sent to an alternate e-mail account selected based upon the size of the message. Further, associating the priority level can include determining a size of the message and selecting the priority level based on the size of the message. Associating the priority level with the message also can include identifying a priority level assigned to a contact from whom the message originated or to whom the message is to be sent. A low priority level can be assigned to the message if the contact from whom the message originated or to whom the message is to be sent is not contained in a contact list. In another arrangement, associating the priority level with the message can include receiving a user input identifying the priority level. The method also can include disabling a reply response on a communication device.

The present invention also relates to a method for processing calls. The method can include receiving an inbound call and associating a priority level with the call. Responsive to the priority level being low, the call can be automatically sent to voice mail. Responsive to the priority level being high, a call session can be established with a contact placing the inbound call. Associating the priority level with the call can include identifying a priority level assigned to a contact from whom the call originated or a group with which the contact is associated. Associating the priority level with the call also can include assigning a low priority level to the call if the contact from whom the call originated is not contained in a contact list or group list.

The method also can include determining when a present pricing period ends and, responsive to determining that costs for use of communication services in a next pricing period are lower, providing a notification to a user indicating that lower cost communication services are available. In another arrangement, responsive to determining that costs for use of communication services in a next pricing period are lower, the call session can be automatically terminated and a second call session can be established with the contact during the next pricing period.

The method also can include querying a subscriber communication rate plan to determine when there is a discounted communication rate or free communications are available. A user can be notified of the voice mail when the discounted communication rate or the free communications are in effect.

The present invention also relates to a communication device which includes a cost saving application that associates a priority level with a message and automatically selects a time in which to communicate the message based on, at least in part, the associated priority level and a communication rate plan. The cost saving application further can disable a reply response on the communication device. The cost saving application also can select the time to communicate the message by querying a subscriber communication rate plan to determine when there is a discounted communication rate or when free communications are available. The communication device also can include a network adapter that automatically communicates the message at the selected time.

### BRIEF DESCRIPTION OF THE DRAWINGS

Preferred embodiments of the present invention will be described below in more detail, with reference to the accompanying drawings, in which:

FIG. 1 depicts a communications system that is useful for understanding the present invention;

FIG. 2 is a flowchart presenting a method that is useful for understanding the present invention;

FIG. 3 depicts a signal flow diagram that is useful for understanding the present invention;

FIG. 4 depicts the communications system of FIG. 1 during call operation; and

FIG. 5 is a flowchart presenting another method that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a method for operating a communication device in a cost saving mode. In the cost saving mode, priority levels can be associated with messages, such as text messages, multimedia messaging service (MMS) files, e-mails and voice mails. Priority levels also can be assigned to phone book contacts and/or contacts associated with recent calls. Thus, a user can define who are low priority, mid priority and high priority contacts. Based on the assigned priority levels and communication rate plan information (e.g. pricing information and group information, such as friends and family), times can be selected for communicating messages and receiving calls to obtain the benefit of lower priced or free communication services during non-peak pricing periods. For example, high priority messages can be communicated immediately, while delivery of lower priority messages can occur at a later time when communication rates are lower. Similarly, low priority calls received during peak pricing periods can be sent directly to voice mail. Further, if a call session is established during a first pricing period, but the call session continues into a second, lower cost, pricing period, the call session can be automatically terminated and reestablished (or reinstated using an existing three way calling feature) to obtain the benefit of lower pricing during the lower cost pricing period.

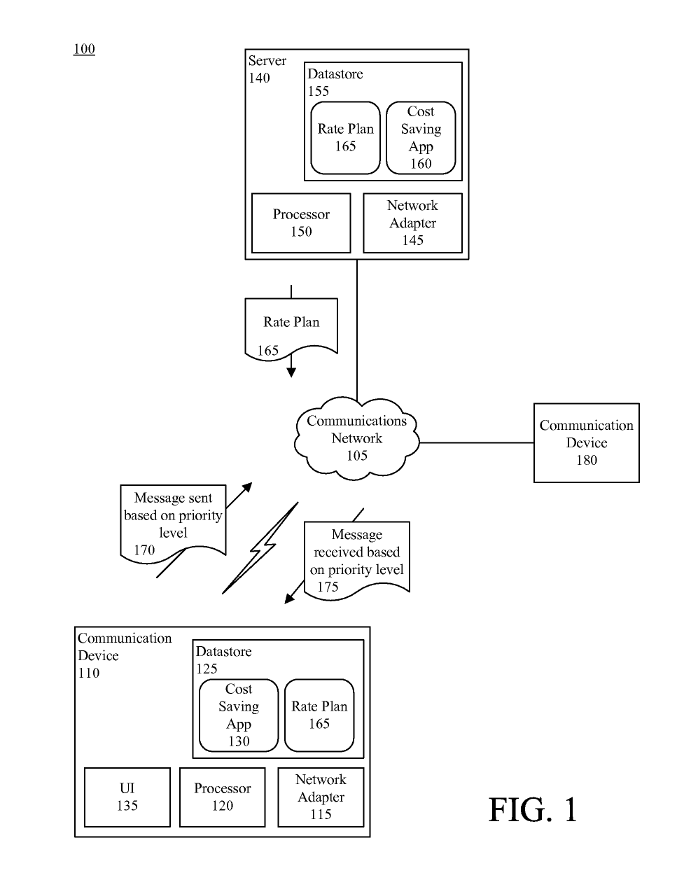

FIG. 1 depicts a communications system 100 that is useful for understanding the present invention. The communications system 100 can include a communications network 105, which can comprise, for example, the Internet, the World Wide Web, a wide area network (WAN), a local area network (LAN), a cellular communications network, a dispatch communications network, an interconnect communications network, a public switched telephone network (PSTN), and/or any other networks or systems over which communication signals can be propagated. In that regard, the communications network can include wired and/or wireless communication links.

The communications system 100 can include a communication device 110. The communication device 110 can be a mobile station, such as a mobile computer, a personal digital assistant (PDA) or a mobile telephone, a game console, a set top box, or any other electronic apparatus that may be used to telecommunicate and/or communicate messages, such as text messages, MMS files, e-mails and voice mails. As such, the communication device 110 can include a network adapter 115 to send and receive messages via the communications network 105. The network adapter 115 can include, for example, a transceiver that communicates data via IEEE 802 wireless communications, WPA, WPA2, GSM, TDMA, CDMA, WCDMA, direct wireless communication or any other suitable form of wireless communications. The network adapter 115 also can comprise wired communications components in addition to, or in lieu of, the transceiver. Such wired communications components can communicate, for instance, using TCP/IP and/or any other suitable form of wired communications.

The communication device 110 also can include a processor 120. The processor 120 can comprise, for example, a central processing unit (CPU), a digital signal processor (DSP), an application specific integrated circuit (ASIC), a programmable logic device (PLD), a plurality of discrete components that cooperate to process data, and/or any other suitable processing device.

The communication device 110 further can include a datastore 125. The datastore 125 can include one or more storage devices, each of which can include a magnetic storage medium, an electronic storage medium, an optical storage medium, a magneto-optical storage medium, and/or any other storage medium suitable for storing digital information. In one arrangement, the datastore 125 can be integrated into the processor 120. A cost saving application 130 can be contained on the datastore 125. The cost saving application 130 can be executed by the processor 120 to implement the methods and processes described herein which are allocated to the communication device 110.

A user interface 135 also can be provided with the communication device 110. The user interface 135 can include, for instance, audio input and output devices, a keypad, a keyboard, buttons, a mouse, a display, a touch screen, a tablet screen and/or any other devices suitable for receiving user inputs and presenting information to a user.

The communications system 100 also can include a server 140. The server can be a base transceiver station (BTS), a base station controller (BSC), a mobile switching center (MSC), a network server, or any other network device suitable for implementing the server functions described herein.

The server 140 can include a network adapter 145. As noted for the network adapter 115, the network adapter 145 can include, for example, a transceiver that communicates data via wireless communications and/or wired communications. The server 140 also can include a processor 150, such as a CPU, a DSP, an ASIC, a PLD, a plurality of discrete components that cooperate to process data, and/or any other suitable processing device. Further, the server 140 can include a datastore 155 on which a cost saving application 160 is stored. The datastore 155 can include one or more storage devices. The cost saving application 160 can be executed by the processor 150 to implement the methods and processes described herein which are allocated to the server 140.

Communication rate plan information 165 for an account with which the communication device 110 is associated also can be contained on the datastore 155, for instance on the same storage device as the cost saving application 160, or on another storage device. In another arrangement, the communication rate plan information 165 otherwise can be made accessible to the server 140. For example, the rate plan information 165 can be provided in a database from which the server 140 can receive data.

The rate plan information 165 can comprise, for instance, information regarding a subscriber's communication rate plan, including communication rates for various time periods and time periods in which communications to/from the communication device 110 are free or discounted. The rate plan information 165 also can identify the communication service provider. The rate plan information 165 can be periodically provided to the communication device 110, or provided each time a message or call is to be communicated to or from the communication device 110.

On the communication device 110, the rate plan information 165 can be stored on the datastore 125. As noted, the datastore 125 can include one or more storage devices. In that regard, the rate plan information 165 may be stored on the same storage device as the cost saving application 130, or on another storage device.

In operation, a user of the communication device 110 can select a cost saving mode for the communication device 110. When a cost saving mode is selected, a message 170 that is to be sent by the communication device 110, for example to a communication device 180, can be prioritized. The message 170 can be prioritized by the user when the message 170 is generated, prioritized by the cost saving application 130, or prioritized by the cost saving application 160. For example, the cost saving application 130 can include a prioritization algorithm and/or configurable prioritization settings. In one arrangement, prioritization of the message 170 can be based, at least in part, on the intended recipient. For example, user contacts contained in an address book can be assigned priority levels, and such priority levels can be processed when determining the priority level of the message 170. The priority levels can be assigned to groups of contacts, for example to family members, friends, co-workers, superiors, etc., and/or assigned individually to contacts. In addition, the size of the message to be sent also can be considered when generating the message priority level.

Similarly, a message 175 to be received by the communication device 110 also can be prioritized, and the rate plan information 165 can be queried by, and processed by, the cost saving application 160 on the server 140 to select a time in which to communicate the message 175 to the communication device 110. The server 140 can receive an indicator for the cost saving mode that is to be implemented. The indicator can be retrieved from a data file associated with a user account or received from the communication device 110.

A plurality of cost saving modes can be available. For example, available cost saving modes can include a high saving mode, a mid saving mode and a low saving mode. In high saving mode, low priority messages can be communicated during periods in which such communications are free or otherwise the lowest price, for instance at night or on weekends for a communication service that provides free nights and weekends. Examples of low priority messages can include large files (e.g. picture, audio and video files), messages to/from contacts identified as low priority, and messages communicated to large groups. Mid-priority messages can be sent or received when a discounted communication rate is available or when roll over minutes may be used. Highest priority messages can be sent or received immediately.

To further reduce costs while in high saving mode, message reply can be disabled. For example, short message service (SMS) responses can be disabled on the communication device 110. Similarly, for messages 170 that are sent, requirement for a reply from the receiving communication device 180 can be disabled.

Another cost saving measure that can be implemented can include configuring an alternate e-mail account for those messages that exceed a predetermined size. For example, if the communication device 110 is communicatively linked to another communications network (not shown), large outbound messages 170 can be routed to the other communications network by the communication device 110 and sent from the alternate e-mail account. Similarly, large inbound messages 175 can be routed to the alternate e-mail account by the server 140. Notification of such delivery can be provided to the communication device 110. Since only a notification of the large e-mail is communicated over the communications network 105, the mobile station 110 will be connected to the network 105 in less time than would be required to download the large message 175, thereby reducing the costs of receiving the message 175. The large message then can be downloaded at a later time when communication charges are reduced or communications are free. In one aspect of the invention, the large messages can be automatically downloaded at such time that the communication charges are reduced or communications are free.

Another cost saving measure that may be implemented can include identifying contacts with whom free messaging/calling is available, even during peak pricing periods. For example, a particular communications service provider may provide free communications among a group of users, such as those users who share an account or those users who subscribe to the provider's communication services. That provider's communication services then can be used by the communication device to communicate with the identified contacts.

In yet another arrangement, the cost saving application 130 can track time that the communication device 110 has used during a billing cycle or access account information for the communication device 110 from the server 140. If there is unused time (e.g. unused plan minutes) or unused message packet data allocations toward an end of a billing cycle, the communication device 110 can send and/or receive any residual messages 170, 175, regardless of the current pricing period. Such unused time may already be paid for and lost if not used, thus use of such time to communicate residual messages 170, 175 may reduce costs for the next billing cycle.

In the mid cost saving mode, highest priority messages still can be communicated immediately, while other messages can be communicated during a time period when communication rates are discounted. In an arrangement when additional charges apply to text messages and/or e-mails which exceed a maximum number of characters, the cost saving application 130 can count characters in outbound messages 170 and provide an indicator via a user interface to notify a user that additional charges will be incurred for communication of the message. The user then can be prompted to select whether to send the messages 170 immediately, send the messages 170 at a later time, direct the messages 170 to a different communications network, or cancel the messages 170. Likewise, the cost saving application 160 on the server 140 can count characters in inbound messages 175. In one arrangement, the server 140 can automatically process such messages 175 in accordance with user and/or system settings, or send notifications of the messages 175 to the communication device 110 and prompt the user to select message handling options. For example, the user can be prompted with options to deliver the messages 175 immediately, deliver the messages 175 during selected pricing periods, send the messages 175 to an alternate delivery account, or to delete the messages 175.

In low saving mode, all messages 170, 175 can be sent and/or received immediately, and messages 170, 175 that are pending delivery, or were previously routed to an alternate address, can be delivered. Notably, other cost saving schemes also may be implemented and the invention is not limited in this regard.

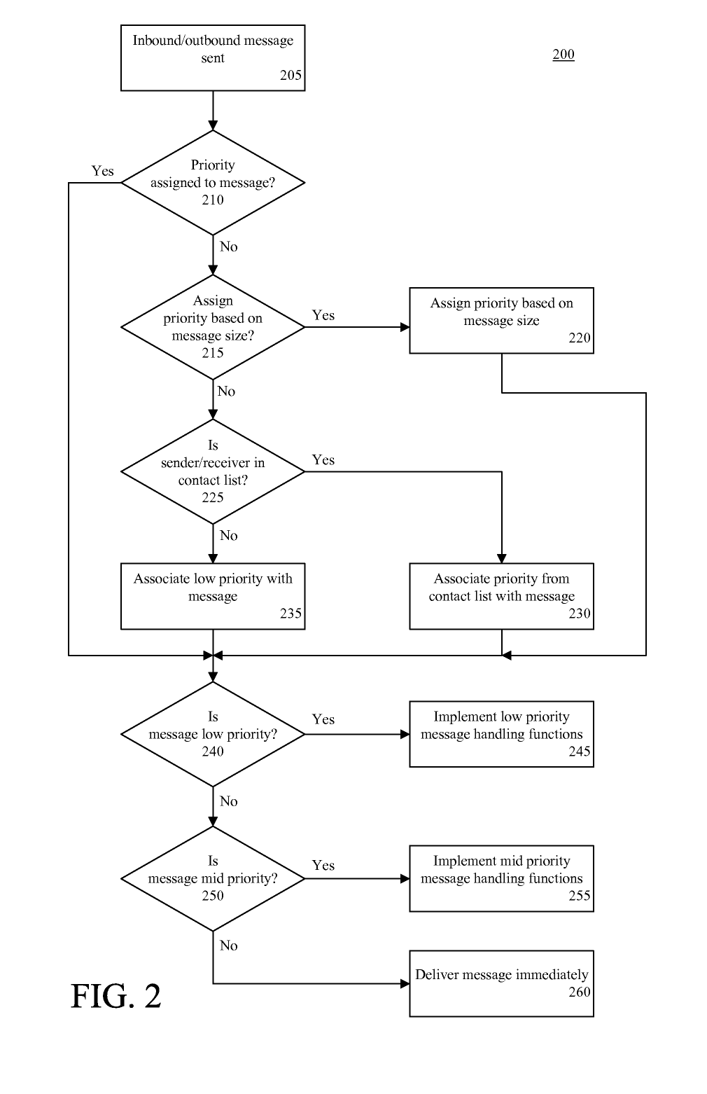

FIG. 2 is a flowchart presenting a method 200 that is useful for understanding the present invention. Beginning at step 205, an outbound message can be sent by the communication device or an inbound message can be sent to the communication device. Referring to decision box 210, if a priority is already assigned to the message, the process can proceed to decision box 240, which will be described. If, however, a priority is not already assigned to the message, the process can proceed to decision box 215. If the system is configured to assign priority based on message size, at step 220 the message can be assigned a priority based on its size. For instance, large messages, such as those with large attachments, can be assigned low priority, while small messages can be assigned mid priority or high priority.

If priority is not assigned based on message size, the process can proceed to decision box 225 and a determination can be made whether the sender of the inbound message or the receiver of the outbound message is in a contact or group list associated with the communication device. If so, at step 230 a priority assigned to the sender/receiver can be associated with the message. If the sender/receiver is not contained in the contact list, at step 235 a low priority can be associated with the message. Alternatively, in the case of an outbound message, a user of the communication device 110 can be prompted to enter a priority to be associated with the message.

Referring to decision box 240, if the message is low priority, at step 245 message handling functions for low priority messages can be implemented. If the message is not low priority, at decision box 250 a determination can be made whether the message is mid priority. If so, at step 255 message handling functions for mid priority messages can be implemented. Otherwise, at step 260 the message can be considered high priority and delivered immediately.

Referring again to FIG. 1, for messages that are voice mails, voice mail notifications can be presented on the communication device 110. The voice mail notifications can indicate telephone numbers from which the voice mails were received and the priority associated with the voice mails. The priority can be accessed from, for example, a user contact list contained on the communication device 110 or a contact list that can be accessed by the server 140. In another arrangement, a user of another communication device, such as the communication device 180 who is leaving a voice mail, can be prompted to enter a priority level for the voice mail. If the user fails to enter a priority level, a default priority, such as low priority, can be assigned to the voice mail.

When voice mails are received, a user of the communication device 110 can be provided with an option to select voice mails for download. In high cost saving mode, however, low priority voice mails (or mid priority voice mails) can be eliminated, or hidden, from a list of voice mails that is presented to the user during peak pricing periods. Instead, the low priority voice mails can be presented during discounted or free pricing periods. Alternatively, low priority voice mails (or mid priority voice mails) can be presented, but download of such voice mails can be blocked during peak pricing periods.

In high cost saving mode, even high priority messages that have already been presented to the user can be blocked from download during peak pricing periods. In the mid saving mode, such voice mails that are high priority still can be presented to the user and delivered upon request. In low cost saving mode, all voice mails can be delivered when received.

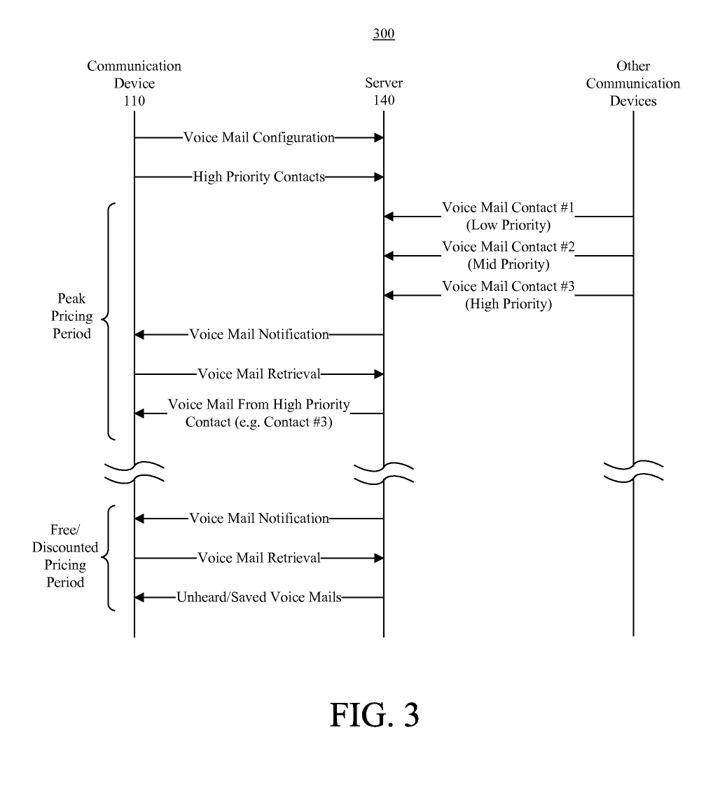

FIG. 3 presents a signal flow diagram 300 that is useful for understanding voice mail handling operations that may be implemented by the communications system. The signal flow diagram 300 represents signals that can be exchanged in an arrangement in which the server 140 is tasked with voice mail handling operations. In response to the communication device 110 establishing presence on the communications network or a cost saving mode being implemented, the communication device 110 can communicate voice mail configuration information to the server 140. The communication device 110 also can communicate identifiers for high priority contacts to the server 140. The identifiers can comprise user identifiers, telephone numbers and/or any other suitable identifiers.

During a high or peak pricing period, the server 140 can receive voice mails from other communication devices. For example, the server can process any calls from low or mid priority contacts, such as contacts #1 and #2, by sending the calls to voice mail (i.e. processing the calls in a manner that prompts the contacts to leave voice mails). A high priority contact, such as contact #3, can be sent to voice mail if the user of the communication device 110 is unavailable when the call is received. In response to receiving the voice mail from the high priority contact #3, a voice mail received notification can be sent from the server 140 to the communication device 110. When the user of the communication device 110 wishes to retrieve his voice mail, the communication device 110 can forward a voice mail retrieval message to the server 140. In response, the server 140 can forward the voice mail generated by the high priority contact #3 to the communication device 110.

Later, during a free or discounted pricing period, the server 140 can communicate a voice mail notification to the communication device 110. When the user of the communication device 110 wishes to once again retrieve his voice mail, the communication device 110 can forward a voice mail retrieval message to the server 140. In response, the server 140 can provide to the communication device 110 any unheard or saved voice mails, including those that are low priority or mid priority.

In another arrangement, in response to the server 140 acknowledging presence of the communication device 110 after the communication device 110 has exited standby mode and established a presence on the communications network, the communication device 110 can send a message to the server 140 notifying the server 140 that it only wants to receive voice mails/calls having a particular priority level. For instance, the communication device 110 can indicate that it only wants to receive mid priority and high priority voice mails and calls. Low priority calls can be sent to voice mail and the low priority voice mails can be held until such time the communication device 110 requests to receive such voice mails, or discounted or free communication rates are available. Mid priority and high priority voice mails and calls can be delivered immediately.

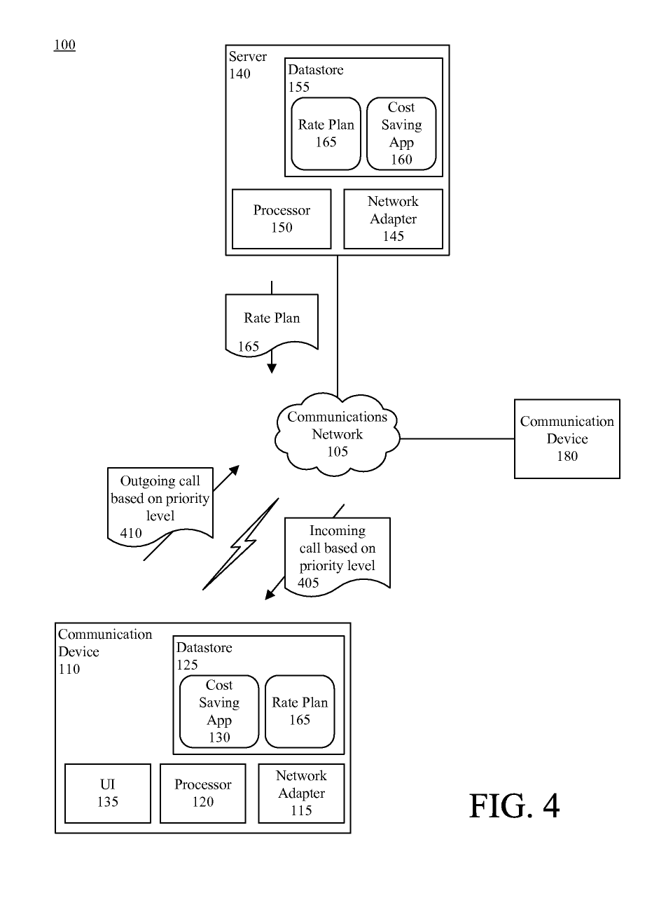

FIG. 4 depicts the communications system 100 during call operation. As with messages, priority levels also can be assigned to incoming calls 405. For example, priority levels assigned to contacts or groups of contacts in the contact list can be associated with incoming calls 405. The incoming calls 405 then can be processed based on associated priorities. In one arrangement, the contact list used by the communication device 110 can be maintained on the server 140 and accessed when processing incoming calls 405. In another arrangement, the server 140 can notify the communication device 110 of the incoming calls 405 and the incoming device can respond with a call handling indicator (i.e. allow call, send call to voice mail, or block call).

For example, while the communication device 110 is operating in high saving mode, calls received from friends during business hours can be considered low priority and blocked or sent directly to voice mail. Calls from family members during business hours can be considered mid priority and routed directly to voice mail. In one arrangement, however, family members can be provided a pre-arranged code that may be entered during an emergency to prevent the call from being automatically sent to voice mail. The cost saving application 130 on the communication device 110 or the call saving application 160 on the server 140 can be provided the code in advance and process such code when entered by a user of the communication device 180. Of course, calls from business associates during business hours can be given high priority and immediately processed to establish a call session. Calls received from unrecognized telephone numbers, or from contacts not identified in the contact list or group or in a recent callers list, can be blocked, immediately sent to voice mail, or processed in another suitable manner.

If a user of the communication device 110 is not present when an incoming call 405 is placed, for instance the user is not registered on the network, the call can be sent directly to voice mail or blocked without waiting for an introduction to be played. Accordingly, charges that otherwise would be incurred while ringtones are played can be avoided. If a particular communications service provider charges for voice mails, voice mail operations for the communication device 110 also can be turned off.

Similarly, if an outgoing call 410 placed by the communication device 110 to the communication device 180 is transferred to voice mail while the communication device 110 is in high cost saving mode, the communication device 110 can automatically send an indicator to bypass the voice mail greeting. For example, if the “#” key can be depressed on the communication device 110 to bypass the voice mail greeting, the communication device 110 can automatically send an indicator to the communication network's voice mail handling system that correlates to the “#” key being depressed. The user then can immediately enter a voice mail for the communication device 180. In bypassing the voice mail greeting, the amount of time that a call session is active to communicate the voice mail can be reduced.

While in high cost saving mode, the communication device 110 can notify a user, via the user interface 135, of the current pricing period when the user is placing an outbound call 410, thereby providing the user an opportunity to cease placing the call prior to incurring charges. The communication device 110 also can present to the user an indicator that indicates when the next pricing period begins and whether such pricing period is a higher or a lower priced period. Similarly, if a user is established in a call session while an incoming call 405 is received, the communication device 110 can notify the user that additional charges will be incurred if both call sessions are maintained (e.g. one call placed on hold while the other call is answered).

If the user happens to be in a call session that is established during a first pricing period, but the call session continues into a second, lower cost pricing period, the communication device 110 can notify the user, again via the user interface 135, that the user may save costs by terminating the call session and establishing a new call session. In one arrangement, the communication device 110 can automatically terminate the original call session and reestablish a new call session to obtain the benefit of lower pricing during the lower cost pricing period.

If the communication device 110 is capable of multiple simultaneous call sessions to the communication device 180, the original call session can be automatically ended and the second call session can be automatically initiated in a manner that is seamless to the user. For example, a second transceiver can be used to establish the second call session as a second communication link to the communication device 180. Group calling features that may be available on the communication device 180 can facilitate such operations. In such an arrangement, the communication device 180 also can include a cost saving application (not shown) that interfaces with the cost saving application 130.

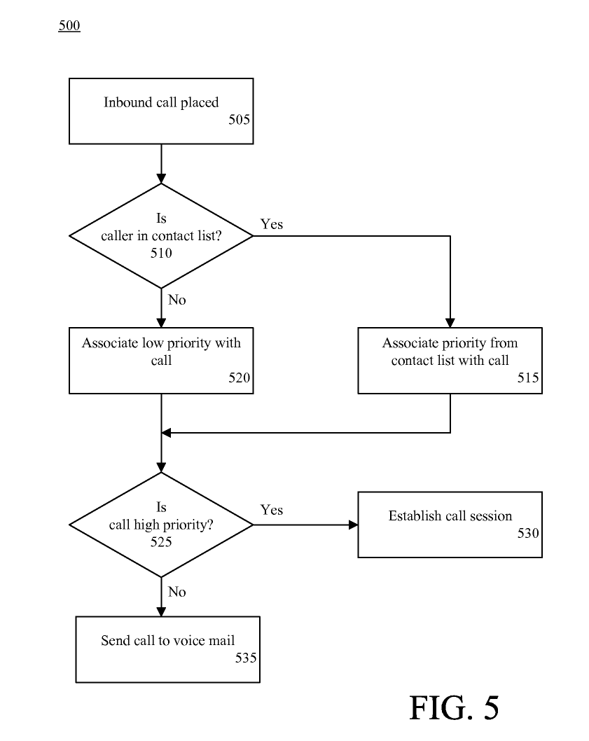

FIG. 5 is a flowchart presenting another method 500 that is useful for understanding the present invention. Beginning at step 505, an inbound call can be placed to the communication device. Referring to decision box 510, if the caller is in a contact or group list associated with the communication device, at step 515 a priority assigned to the caller can be associated with the call. If the caller is not contained in the contact list, at step 520 a low priority can be associated with the call. Referring to decision box 525, if the call is high priority, at step 530 a call session can be established. Otherwise, at step 535 the call can be sent to voice mail.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in an application product, which comprises all the features enabling the implementation of the methods described herein, and which when loaded in a processing system is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

This invention can be embodied in other forms without departing from the spirit or essential attributes thereof. Accordingly, reference should be made to the following claims, rather than to the foregoing specification, as indicating the scope of the invention.

What is claimed is:

1. A method for communicating messages, comprising:
associating a priority level with a message;
automatically selecting a time in which to communicate the message based on, at least in part, the associated priority level and a communication rate plan; and
automatically communicating the message at the selected time.

2. The method of claim 1, wherein selecting the time to communicate the message comprises querying the subscriber communication rate plan to determine when there is a discounted communication rate or when free communications are available.

3. The method of claim 1, wherein automatically communicating the message at the selected time comprises communicating the message immediately in response to the priority that is associated with the message being high.

4. The method of claim 1, further comprising disabling a reply response on a communication device.

5. The method of claim 1, wherein associating the priority level comprises:
determining a size of the message; and
selecting the priority level based on the size of the message.

6. The method of claim 1, wherein automatically communicating the message comprises communicating the message to an alternate e-mail address.

7. The method of claim 1, further comprising:
determining a size of the message;
wherein automatically communicating the message comprises sending the message to an alternate e-mail account selected based upon the size of the message.

8. The method of claim 1, wherein associating the priority level with the message comprises identifying a priority level assigned to a contact from whom the message originated or to whom the message is to be sent.

9. The method of claim 1, wherein associating the priority level with the message comprises assigning a low priority level to the message if the contact from whom the message originated or to whom the message is to be sent is not contained in a contact list.

10. The method of claim 1, wherein associating the priority level with the message comprises receiving a user input identifying the priority level.

11. A method for processing calls, comprising:
receiving an inbound call;
associating a priority level with the call;
responsive to the priority level being low, automatically sending the call to voice mail.

12. The method of claim 11, further comprising:
responsive to the priority level being high, establishing a call session with a contact placing the inbound call.

13. The method of claim 12, further comprising:
determining when a present pricing period ends; and
responsive to determining that costs for use of communication services in a next pricing period are lower, providing a notification to a user indicating that lower cost communication services are available.

14. The method of claim 12, further comprising:
determining when a present pricing period ends; and
responsive to determining that costs for use of communication services in a next pricing period are lower, automatically terminating the call session and establishing a second call session with the contact during the next pricing period.

15. The method of claim 11, further comprising:
querying a subscriber communication rate plan to determine when there is a discounted communication rate or free communications are available; and
notifying a user of the voice mail when the discounted communication rate or the free communications are in effect.

16. The method of claim 11, wherein associating the priority level with the call comprises identifying a priority level assigned to a contact from whom the call originated or a group with which the contact is associated.

17. The method of claim 11, wherein associating the priority level with the call comprises assigning a low priority level to the call if the contact from whom the call originated is not contained in a contact list or group list.

18. A communication device, comprising:
a cost saving application that associates a priority level with a message and automatically selects a time in which to communicate the message based on, at least in part, the associated priority level and a communication rate plan, and
a network adapter that automatically communicates the message at the selected time.

19. The communication device of claim 18, wherein the cost saving application selects the time to communicate the message by querying a subscriber communication rate plan to determine when there is a discounted communication rate or when free communications are available.

20. The communication device of claim 18, wherein the cost saving application further disables a reply response on the communication device.
